(19) United States
(12) Patent Application Publication
(10) Pub. No.: US 2022/0298371 A1
(43) Pub. Date: Sep. 22, 2022

(54) Ink-Jet Ink Composition, Method For Manufacturing Recorded Material, Recorded Material, And Recording Apparatus

(71) Applicant: Seiko Epson Corporation, Tokyo (JP)

(72) Inventors: Soichi YAMAZAKI, Shiojiri (JP); Naoyuki TOYODA, Suwa (JP); Koji HORIBA, Matsumoto (JP); Koichi TERAO, Suwa (JP); Nikako TSUKIJI, Matsumoto (JP)

(21) Appl. No.: 17/699,228

(22) Filed: Mar. 21, 2022

(30) Foreign Application Priority Data
Mar. 22, 2021 (JP) 2021-046983

(51) Int. Cl. C09D 11/328; C09D 11/104; C09D 11/033; C09D 11/322; C09D 11/324; C09D 11/037; C09D 11/40; B41J 2/01; B41M 5/50

(52) U.S. Cl. CPC C09D 11/328; C09D 11/104; C09D 11/033; C09D 11/322; C09D 11/324; C09D 11/037; C09D 11/40; B41J 2/01; B41M 5/502

(57) ABSTRACT

An ink-jet ink composition contains water, a colorant, and resin particles made of a material containing polyester. The polyester has a sulfo group and contains a diol component and a dicarboxylic acid component. The diol component contains a diol component having a 1,3-propanediol skeleton.

The present application is based on, and claims priority from JP Application Serial Number 2021-046983, filed Mar. 22, 2021, the disclosure of which is hereby incorporated by reference herein in its entirety.

### BACKGROUND

### 1. Technical Field

The present disclosure relates to an ink-jet ink composition, a method for manufacturing a recorded material, a recorded material, and a recording apparatus.

### 2. Related Art

In recent years, ink jet printers have been widely used and have been used not only as office and home printers, but also for commercial printing, textile printing, and the like.

An aqueous ink-jet ink composition containing a fixing resin such as an acrylic resin, a urethanic resin, or a polyester resin is used for the purpose of enhancing fixability to recording media such as fabrics and the fastness of recorded materials (refer to, for example, JP-A-2020-2219).

Printing on stretchable clothes, films that are bent or are stretched, and the like is increasingly performed and therefore requirements for texture and touch are growing.

However, hitherto, the texture, such as flexibility, and fixing strength of recorded materials have been poor. In particular, hitherto, when an acrylic resin or a polyester resin has been used as a fixing resin, the stretchability of a recorded portion formed using an ink-jet ink composition has been insufficient and, when a urethanic resin has been used as a fixing resin, there has been a problem that texture is poor due to tackiness.

Examples of an ink jet printing method that does not impair the texture of fabric or film include sublimation transfer, which has a problem that it is difficult to apply sublimation transfer to textiles other than polyester textiles.

### SUMMARY

The present disclosure has been made to solve the above problems and can be implemented as aspects below.

According to an aspect of the present disclosure, an ink-jet ink composition contains water, a colorant, and resin particles made of a material containing polyester. The polyester has a sulfo group and contains a diol component and a dicarboxylic acid component. The diol component contains a diol component having a 1,3-propanediol skeleton.

According to another aspect of the present disclosure, the ink-jet ink composition contains a plurality of types of components as the diol component having a 1,3-propanediol skeleton.

According to another aspect of the present disclosure, the ink-jet ink composition contains at least one selected from the group consisting of 1,3-propanediol, methylpropanediol, neopentyl glycol, methylethylpropanediol, diethylpropanediol, and butylethylpropanediol as the diol component having a 1,3-propanediol skeleton.

According to another aspect of the present disclosure, in the ink-jet ink composition, the polyester further contains at least one of ethylene glycol and 1,2-propanediol as the diol component in addition to the diol component having a 1,3-propanediol skeleton.

According to another aspect of the present disclosure, the ink-jet ink composition contains a plurality of types of components as the dicarboxylic acid component.

According to another aspect of the present disclosure, in the ink-jet ink composition, the polyester contains a dicarboxylic acid component with a sulfonated chemical structure as the dicarboxylic acid component.

According to another aspect of the present disclosure, the ink-jet ink composition contains an aromatic dicarboxylic acid as the dicarboxylic acid component.

According to another aspect of the present disclosure, in the ink-jet ink composition, the colorant is at least one selected from the group consisting of a dye, an organic pigment, and an inorganic pigment.

According to another aspect of the present disclosure, in the ink-jet ink composition, the colorant is contained in the resin particles.

According to another aspect of the present disclosure, in the ink-jet ink composition, the colorant is at least one selected from the group consisting of an oily dye, a disperse dye, a sublimation dye, a fluorescent dye, a direct dye, a pigment, and carbon black.

According to an aspect of the present disclosure, a method for manufacturing a recorded material includes an application step of applying the ink-jet ink composition according to an aspect of the present disclosure to a recording medium by ejecting the ink-jet ink composition by an ink jet process.

According to another aspect of the present disclosure, the method for manufacturing a recorded material further includes a heating step of heating the recording medium provided with the ink-jet ink composition.

According to another aspect of the present disclosure, in the method for manufacturing a recorded material, the recording medium is fabric.

According to another aspect of the present disclosure, in the method for manufacturing a recorded material, the heating temperature of the recording medium in the heating step is 80° C. to 180° C.

According to an aspect of the present disclosure, a recorded material includes a recording medium and a recorded portion formed using an ink-jet ink composition. The recorded portion is made of a colorant and a material containing polyester. The polyester has a sulfo group and contains a diol component having a 1,3-propanediol skeleton and a dicarboxylic acid component.

According to an aspect of the present disclosure, a recording apparatus includes an ink jet head configured to eject an ink-jet ink composition according to an aspect of the present disclosure toward a recording medium by an ink jet process.

According to another aspect of the present disclosure, the recording apparatus further includes a heating mechanism configured to heat the recording medium.

### BRIEF DESCRIPTION OF THE DRAWINGS

FIG. 1s a schematic perspective view of a recording apparatus according to a preferred embodiment of the present disclosure.

### DESCRIPTION OF EXEMPLARY EMBODIMENTS

Preferred embodiments of the present disclosure are described below in detail.

### 1. Ink-Jet Ink Composition

First, an ink-jet ink composition according to the present disclosure is described.

The ink-jet ink composition according to the present disclosure contains water and a colorant.

The ink-jet ink composition contains resin particles made of a material containing polyester. The polyester has a sulfo group and contains a diol component and a dicarboxylic acid component. The diol component contains a diol component having a 1,3-propanediol skeleton.

Satisfying these conditions enables the ink-jet ink composition to be provided such that fixability to recording media is excellent and the texture of a recorded portion formed on a recording medium is excellent. In particular, the polyester has high strength and adhesion and therefore can be satisfactorily used to manufacture a recorded material with excellent durability. In addition, the ejection stability of the ink-jet ink composition by an ink jet process and the storage stability thereof improve.

Reasons why such excellent effects are obtained are probably as described below.

That is, since the diol component having a 1,3-propanediol skeleton is such that the angles of two C—O bonds that form a 1,3-propanediol structure differ, it is conceivable that polyester molecules are nonlinear, are likely to expand and contract, and form a flexible resin. As a result, a recorded portion that is soft and is unlikely to crack even when being elongated can be satisfactorily formed. In general, unlike urethane resins and the like, polyesters have low tackiness, exhibit smooth touch, and can form a recorded portion with excellent texture. Since the diol component having a 1,3-propanediol skeleton, which has the above feature, is contained, the polyester forming the resin particles is highly amorphous and crystallizes with time and the whitening or precipitation of the polyester is effectively prevented, resulting in the improvement in dispersion stability of the resin particles in the ink-jet ink composition. Since the polyester has a sulfo group, the hydrophilicity of the polyester can be appropriately enhanced and the dispersion stability of the resin particles in the ink-jet ink composition, which contains water, can be enhanced. These probably enhance the ejection stability of the ink-jet ink composition by the ink jet process and the storage stability thereof.

In the present specification, the term “ink-jet ink composition” is a concept that includes ink that is ejected by the ink jet process and a stock solution used to prepare the ink. In other words, the ink-jet ink composition according to the present disclosure may be one that is ejected as-is by the ink jet process or one that is ejected by the ink jet process after treatment such as dilution. Examples of the ink jet process include on-demand systems such as a charge deflection system, a continuous system, a piezoelectric system, and a Bubble Jet® system.

### 1-1. Colorant

The ink-jet ink composition according to the present disclosure contains the colorant. The colorant is a component which colors recording media and which has a significant influence on the appearance of recorded materials.

The colorant may be anything and is preferably at least one selected from the group consisting of dyes, organic pigments, and inorganic pigments.

This allows the affinity between the polyester and the colorant to be more excellent, allows coloring properties of a recorded portion of a recorded material manufactured using the ink-jet ink composition to be more excellent, and allows the fixability of the recorded portion to a recording medium, the durability of the recorded material, and the like to be more excellent.

Examples of the organic pigments include azo pigments such as azo lakes, insoluble azo pigments, condensed azo pigments, and chelate azo pigments; polycyclic pigments such as phthalocyanine pigments, perylene, perylene pigments, anthraquinone pigments, quinacridone pigments, dioxazine pigments, thioindigo pigments, isoindolinone pigments, and quinophthalone pigments; dye chelates such as basic dye chelates and acidic dye chelates; nitro pigments; nitroso pigments; aniline black; and daylight fluorescent pigments.

Examples of the inorganic pigments include titanium oxide, iron oxide, and carbon black. The carbon black used may be one produced by a known method such as a contact method, a furnace method, or a thermal method.

Examples of the dyes include oily dyes, disperse dyes, sublimation dyes, fluorescent dyes, reactive dyes, acidic dyes, sulfide dyes, vat dyes, and cationic dyes.

Examples of the oily dyes include C. I. Solvent Blacks 3, 7, 27, 29, and 34; C. I. Solvent Yellows 14, 16, 19, 29, 56, and 82; C. I. Solvent Reds 1, 3, 8, 18, 24, 27, 43, 51, 72, 73, 132, and 218; C. I. Solvent Violet 3; C. I. Solvent Blues 2, 11, and 70; C. I. Solvent Greens 3 and 7; and C. I. Solvent Orange 2.

Examples of the disperse and sublimation dyes include C. I. Disperse Yellows 1, 3, 4, 5, 7, 9, 13, 23, 24, 30, 33, 34, 42, 44, 49, 50, 51, 54, 56, 58, 60, 61, 63, 64, 66, 68, 71, 74, 76, 79, 82, 83, 85, 86, 88, 90, 91, 93, 98, 99, 100, 104, 108, 114, 116, 118, 119, 122, 124, 126, 135, 140, 141, 149, 154, 160, 162, 163, 164, 165, 179, 180, 182, 183, 184, 186, 192, 198, 199, 201, 202, 204, 210, 211, 215, 216, 218, 224, 227, 231, and 232; C. I. Disperse Oranges 1, 3, 5, 7, 11, 13, 17, 20, 21, 25, 29, 30, 31, 32, 33, 37, 38, 42, 43, 44, 45, 46, 47, 48, 49, 50, 53, 54, 55, 56, 57, 58, 59, 60, 61, 66, 71, 73, 76, 78, 80, 89, 90, 91, 93, 96, 97, 119, 127, 130, 139, and 142; C. I. Disperse Reds 1, 4, 5, 7, 11, 12, 13, 15, 17, 27, 43, 44, 50, 52, 53, 54, 55, 56, 58, 59, 60, 65, 72, 73, 74, 75, 76, 78, 81, 82, 86, 88, 90, 91, 92, 93, 96, 103, 105, 106, 107, 108, 110, 111, 113, 117, 118, 121, 122, 126, 127, 128, 131, 132, 134, 135, 137, 143, 145, 146, 151, 152, 153, 154, 157, 159, 164, 167, 169, 177, 179, 181, 183, 184, 185, 188, 189, 190, 191, 192, 200, 201, 202, 203, 205, 206, 207, 210, 221, 224, 225, 227, 229, 239, 240, 257, 258, 277, 278, 279, 281, 288, 298, 302, 303, 310, 311, 312, 320, 324, 328, and 364; C. I. Disperse Violets 1, 4, 8, 23, 26, 27, 28, 31, 33, 35, 36, 38, 40, 43, 46, 48, 50, 51, 52, 56, 57, 59, 61, 63, 69, and 77; C. I. Disperse Green 9; C. I. Disperse Browns 1, 2, 4, 9, 13, and 19; C. I. Disperse Blues 3, 7, 9, 14, 16, 19, 20, 24, 26, 27, 35, 43, 44, 54, 55, 56, 58, 60, 62, 64, 71, 72, 73, 75, 79, 81, 82, 83, 87, 91, 92, 93, 94, 95, 96, 102, 106, 108, 112, 113, 115, 118, 120, 122, 125, 128, 130, 139, 141, 142, 143, 146, 148, 149, 153, 154, 158, 165, 167, 171, 173, 174, 176, 181, 183, 185, 186, 187, 189, 197, 198, 200, 201, 205, 207, 211, 214, 224, 225, 257, 259, 267, 268, 270, 284, 285, 287, 288, 291, 293, 295, 297, 301, 315, 330, 333, 359, and 360; and C.

### I. Disperse Blacks 1, 3, 10, and 24.

Examples of the fluorescent dyes include C. I. Disperse Red 364, C. I. Disperse Red 362, C. I. Vat Red 41, C. I. Disperse Yellow 232, C. I. Disperse Yellow 184, C. I. Disperse Yellow 82, and C. I. Disperse Yellow 43.

Examples of the reactive dyes include yellow dyes such as C. I. Reactive Yellows 2, 3, 18, 81, 84, 85, 95, 99, and 102; orange dyes such as C. I. Reactive Oranges 5, 9, 12, 13, 35, 45, and 99; brown dyes such as C. I. Reactive Browns 2, 8, 9, 17, and 33; red dyes such as C. I. Reactive Reds 1, 3, 4, 13, 15, 24, 29, 31, 33, 120, 125, 151, 206, 218, 226, and 245; violet dyes such as C. I. Reactive Violet 24; blue dyes such as C. I. Reactive Blues 2, 5, 10, 13, 14, 15, 15:1, 21, 49, 63, 71, 72, 75, 162, 176, 4, 19, and 198; green dyes such as C. I. Reactive Greens 5, 8, and 19; and black dyes such as C. I. Reactive Blacks 1, 8, 23, and 39.

The colorant may be contained in the ink-jet ink composition in any form. For example, the colorant may be contained in the resin particles as described below or may be contained in a form independent of the resin particles.

In particular, when the colorant is contained in the resin particles, coloring properties of the recorded portion of the recorded material manufactured using the ink-jet ink composition are allowed to be more excellent and the fixability of the recorded portion to a recording medium, the durability of the recorded material, and the like are allowed to be more excellent. In addition, the storage stability of the ink-jet ink composition is more excellent.

When the colorant is contained in the resin particles, the colorant is preferably at least one selected from the group consisting of oily dyes, disperse dyes, sublimation dyes, fluorescent dyes, direct dyes, pigments, and carbon black.

This allows the affinity between the polyester and the colorant to be more excellent, allows the colorant to be satisfactorily contained in the resin particles in, for example, the ink-jet ink composition, particularly the resin particles to be dyed, and allows the coloring properties of the recorded portion of the recorded material manufactured using the ink-jet ink composition to be more excellent. Since excellent coloring properties are exhibited even when a recording medium is heat-treated at a relatively low temperature for a relatively short time, the ink-jet ink composition can be satisfactorily applied to a recording medium with low heat resistance, for example, a recording medium made of a material which is melted or unintentionally discolored by heat treatment at a relatively low temperature. This broadens the range of options for recording media. Excellent coloring properties are exhibited even when a recording medium is heat-treated at a relatively low temperature for a relatively short time. This is advantageous from the viewpoint of energy saving and the increase in production efficiency of recorded materials.

The lower limit of the content of the colorant in the ink-jet ink composition is preferably 0.1% by mass, more preferably 0.2% by mass, and further more preferably 0.3% by mass. The upper limit of the content of the colorant in the ink-jet ink composition is preferably 10.0% by mass, more preferably 7.0% by mass, and further more preferably 5.0% by mass.

This allows the coloring properties and optical density of the recorded portion of the recorded material manufactured using the ink-jet ink composition to be more excellent and enables the occurrence of unintentional color unevenness in a recording medium to be effectively prevented.

### 1-2. Water

The ink-jet ink composition contains water. The water mainly has a function of imparting fluidity to the ink-jet ink composition and functions as, for example, a dispersion medium for the resin particles.

The water used may be, for example, pure water such as reverse osmosis (RO) water, distilled water, or ion-exchanged water.

The lower limit of the content of water in the ink-jet ink composition is not particularly limited, is preferably 30.0% by mass, is more preferably 35.0% by mass, and is further more preferably 40.0% by mass. The upper limit of the content of water in the ink-jet ink composition is not particularly limited, is preferably 90.0% by mass, is more preferably 85.0% by mass, and is further more preferably 80.0% by mass.

This enables the viscosity of the ink-jet ink composition to be more reliably adjusted to a preferred value and enables the ejection stability of the ink-jet ink composition by the ink jet process to be further enhanced.

### 1-3. Resin Particles

The ink-jet ink composition according to the present disclosure contains the resin particles, which are made of the material containing the polyester.

As described above, the polyester forming the resin particles has a sulfo group and contains the diol component having a 1,3-propanediol skeleton and the dicarboxylic acid component.

The resin particles have a function of enhancing the fixability and fastness of the recorded portion in the recorded material manufactured using the ink-jet ink composition and also have a function of enhancing the texture and touch thereof.

The lower limit of the average particle size of the resin particles is not particularly limited, is preferably 20 nm, is more preferably 40 nm, and is further more preferably 60 nm. The upper limit of the average particle size of the resin particles is not particularly limited, is preferably 300 nm, is more preferably 250 nm, and is further more preferably 200 nm.

This enables the ink-jet ink composition to be readily prepared and allows the dispersion stability of the resin particles in the ink-jet ink composition, the storage stability of the ink-jet ink composition, and the ejection stability of the ink-jet ink composition by the ink jet process to be more excellent.

In the present specification, the term “average particle size” refers to the volume-based average particle size unless otherwise specified. The average particle size can be determined by measurement using, for example, Microtrac UPA (manufactured by Nikkiso Co., Ltd.).

The lower limit of the content of the resin particles in the ink-jet ink composition according to the present disclosure is preferably 5.0% by mass, more preferably 10.0% by mass, and further more preferably 15.0% by mass. The upper limit of the content of the resin particles in the ink-jet ink composition according to the present disclosure is preferably 40.0% by mass, more preferably 35.0% by mass, and further more preferably 30.0% by mass.

This allows the storage stability of the ink-jet ink composition and the ejection stability of the ink-jet ink composition by the ink jet process to be more excellent, allows the polyester and the colorant to be contained in the ink-jet ink composition at more preferable content, and allows the coloring properties of the recorded portion of the recorded material manufactured using the ink-jet ink composition, the fixability of the recorded portion to a recording medium, the durability of the recorded material, and the like to be more excellent.

### 1-3-1. Polyester

The polyester forming the resin particles is described below in detail.

Polyester, which is a generic term for polymeric materials having an ester bond in a main chain, generally has a chemical structure formed by the dehydration condensation of a polyol component having a plurality of hydroxy groups in a molecule and a polycarboxylic acid having a plurality of carboxy groups in a molecule.

The resin particles contain the polyester, which has a sulfo group and which contains the diol component and the dicarboxylic acid component. The diol component contains the diol component having a 1,3-propanediol skeleton. The resin particles may contain a trivalent or higher polyvalent alcohol component or a trivalent or higher polyvalent carboxylic acid component in addition to the diol component and the dicarboxylic acid component.

The sulfo group may be contained in any site in the polyester. For example, the sulfo group may be contained in the diol component, may be contained in the dicarboxylic acid component, or may be contained in a site other than these. The sulfo group is preferably contained in the dicarboxylic acid component. In other words, the polyester preferably contains a dicarboxylic acid component with a sulfonated chemical structure.

This allows sulfo groups to be more uniformly present in the resin particles, thereby more clearly exhibiting the above-mentioned effect.

### 1-3-1-1. Diol Component

The polyester forming the resin particles contains the diol component having a 1,3-propanediol skeleton as a diol component.

This provides an effect that, when the diol component having a 1,3-propanediol skeleton is incorporated in the polyester, a main chain of the polyester forms a three-dimensional zigzag structure because two carbon-oxygen bonds are in an intersecting positional relationship; a polymer is likely to expand and contract; and a flexible resin is obtained.

The diol having a 1,3-propanediol skeleton is a compound in which each of a 1-position carbon atom and 3-position carbon atom in a propane skeleton is bonded to a hydroxy group and a 2-position carbon atom is bonded to no hydroxy group. Incidentally, the 2-position carbon atom may be bonded to a hydrocarbon group such as methyl or ethyl.

The diol having a 1,3-propanediol skeleton is, for example, a compound represented by the following formula:

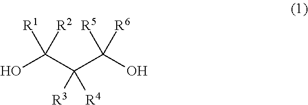

(In Formula (1), R¹ to R⁶ are independently a hydrocarbon group which may have a hydrogen atom, an alkyl group, a sulfo group, or a substituent.)

Examples of the substituent include a sulfo group and a hydroxy group.

The polyester forming the resin particles preferably contains a compound in which at least one of R¹ to R⁶ is a hydrocarbon group in the diol component having a 1,3-propanediol skeleton represented by Formula (1) as one of diol components having a 1,3-propanediol skeleton.

This enables, for example, the hydrophobicity of the polyester to be appropriately enhanced, thereby enabling the polyester to be effectively prevented from being unintentionally dissolved in a dispersion medium mainly containing water even when the ink-jet ink composition is stored in a high-temperature environment or the like. In addition, the water resistance of the recorded material manufactured using the ink-jet ink composition is allowed to be more excellent.

Such effects are more effectively exhibited when the compound in which at least one of R¹ to R⁶ in Formula (1) is the hydrocarbon group accounts for 30 mol % or more of the whole of the diol components having a 1,3-propanediol skeleton in the polyester and are even more effectively exhibited when 50 mol % or more.

The polyester forming the resin particles may contain one of the diol components having a 1,3-propanediol skeleton only and preferably contains two or more of the diol components having a 1,3-propanediol skeleton.

This increases the amorphousness of the polyester, enables crystallization or the like in the ink-jet ink composition or in the recorded portion formed using the ink-jet ink composition to be satisfactorily prevented, and allows the storage stability of the ink-jet ink composition and the reliably of a recorded material to be more excellent.

More specifically, examples of the diol components having a 1,3-propanediol skeleton include 1,3-propanediol, methylpropanediol, neopentyl glycol, methylethylpropanediol, diethylpropanediol, butylethylpropanediol, and compounds obtained by introducing a sulfo group into these. One or more selected from these can be used alone or in combination. At least one selected from the group consisting of 1,3-propanediol, methylpropanediol, neopentyl glycol, methylethylpropanediol, diethylpropanediol, and butylethylpropanediol is preferable.

This provides an effect that, when the diol components having a 1,3-propanediol skeleton are incorporated in the polyester, a main chain of the polyester forms a three-dimensional zigzag structure because two carbon-oxygen bonds are in an intersecting positional relationship; a polymer is likely to expand and contract; and a flexible resin is obtained.

When the polyester contains two or more of the diol components having a 1,3-propanediol skeleton, the diol components having a 1,3-propanediol skeleton preferably include at least 1,3-propanediol.

This provides an effect that molecules are likely to move and a flexible soft resin is obtained because 1,3-propanediol has no side chain.

The polyester forming the resin particles may further contain a diol component having no 1,3-propanediol skeleton as a diol component in addition to the diol components having a 1,3-propanediol skeleton.

Examples of such a diol component include aliphatic diols such as ethylene glycol, 1,2-propanediol, 2,3-butanediol, 1,4-butanediol, 1,5-pentanediol, 1,6-hexanediol, diethylene glycol, dipropylene glycol, polyethylene glycol, and polypropylene glycol; various triols; tetraols; and compounds obtained by introducing a sulfo group into these.

In particular, when at least one of ethylene glycol and 1,2-propanediol is contained together with the diol components having a 1,3-propanediol skeleton, an effect that a soft resin is obtained because a short aliphatic structure is incorporated, alignment is therefore difficult, crystallization is unlikely to occur, and amorphousness increases.

In this case, the lower limit of the proportion of ethylene glycol and 1,2-propanediol in all diol components forming the polyester is preferably 5.0 mol % of and more preferably 10.0 mol %. The upper limit of the proportion of ethylene glycol and 1,2-propanediol in all the diol components forming the polyester is preferably 65.0 mol % and more preferably 50.0 mol %.

The diol components having a 1,3-propanediol skeleton preferably account for 30.0 mol % or more of all the diol components forming the polyester and more preferably 40.0 mol % or more.

### 1-3-1-2. Dicarboxylic Acid Component

The polyester forming the resin particles contains the dicarboxylic acid component together with the diol component.

The dicarboxylic acid component forming the polyester may be one having two or more carboxy groups.

The polyester forming the resin particles may contain one type of dicarboxylic acid component only and preferably contains a plurality of types of dicarboxylic acid components.

This increases the amorphousness of the polyester, enables crystallization or the like in the ink-jet ink composition or in the recorded portion formed using the ink-jet ink composition to be satisfactorily prevented, and allows the storage stability of the ink-jet ink composition and the reliably of a recorded material to be more excellent. In particular, when an aromatic dicarboxylic acid below is contained as a dicarboxylic acid component, the above crystallization is likely to occur. When the polyester contains a plurality of types of dicarboxylic acid components, crystallization can be satisfactorily prevented and an advantage due to the use of the aromatic dicarboxylic acid below can be enjoyed.

In particular, the polyester forming the resin particles preferably contains a plurality of types of diol components having a 1,3-propanediol skeleton and a plurality of types of dicarboxylic acid components. In this case, these effects act synergistically, thereby enabling crystallization or the like in the ink-jet ink composition or in the recorded portion formed using the ink-jet ink composition to be more satisfactorily prevented and allowing the storage stability of the ink-jet ink composition and the flexibility and texture of a recorded material to be more excellent.

The dicarboxylic acid component forming the polyester may be an aliphatic dicarboxylic acid and preferably contains at least the aromatic dicarboxylic acid.

This enables the strength of resin to be increased. For example, the hydrophobicity of the polyester can be satisfactorily increased. Even when the ink-jet ink composition is stored in a high-temperature environment or the like, the polyester can be effectively prevented from being unintentionally dissolved in a dispersion medium mainly containing water. In addition, the water resistance of the recorded material manufactured using the ink-jet ink composition is allowed to be more excellent. When the ink-jet ink composition contains a dye as a colorant, the affinity between the polyester and the colorant can be increased and coloring properties are particularly excellent. The colorant can be satisfactorily contained in the resin particles and the above-mentioned effects are more clearly exhibited.

Examples of the aromatic dicarboxylic acid include aromatic dicarboxylic acids such as terephthalic acid, isophthalic acid, orthophthalic acid, 1,5-naphthalenedicarboxylic acid, 2,6-naphthalenedicarboxylic acid, 2,7-naphthalenedicarboxylic acid, and diphenic acid and compounds obtained by introducing a sulfo group into these. In particular, terephthalic acid, isophthalic acid, and compounds obtained by introducing a sulfo group into these are preferable.

The aromatic dicarboxylic acid preferably accounts for 40.0 mol % or more of the dicarboxylic acid component forming the polyester, more preferably 50.0 mol % or more, and further more preferably 70.0 mol % or more. This more clearly exhibits the above-mentioned effects.

Examples of the aliphatic dicarboxylic acid include aliphatic dicarboxylic acids such as succinic acid, adipic acid, azelaic acid, sebacic acid, and dodecanedicarboxylic acid; fumaric acid; maleic acid; itaconic acid; hexahydrophthalic acid; tetrahydrophthalic acid; cyclohexanedicarboxylic acid; and compounds obtained by introducing a sulfo group into these.

When the polyester contains a plurality of types of dicarboxylic acids, the polyester preferably contains terephthalic acid, isophthalic acid, and compounds obtained by introducing a sulfo group into terephthalic acid and/or isophthalic acid as dicarboxylic acids.

This provides an effect that amorphousness increases because the dicarboxylic acids, which are different in type, have a similar structure and therefore are compatible.

### 1-3-1-3. Another Component

The polyester forming the resin particles may contain a component other than the above-mentioned diol component and dicarboxylic acid component. Examples of such a component include a monovalent carboxylic acid component that esterifies one of hydroxy groups of the diol component forming the polyester and a monovalent alcohol component that esterifies one of carboxy groups of the dicarboxylic acid component forming the polyester.

The component other than the above-mentioned diol component and dicarboxylic acid component in the polyester is preferably 20.0% by mass or less, more preferably 10.0% by mass or less, and further more preferably 5.0% by mass or less.

### 1-3-1-4. Other Conditions

The polyester forming the resin particles preferably meets conditions below.

The lower limit of the degree of sulfonation of the polyester forming the resin particles is preferably 0.5 mol %, more preferably 1.0 mol %, and further more preferably 1.5 mol %. The upper limit of the degree of sulfonation of the polyester forming the resin particles is preferably 15.0 mol %, more preferably 10.0 mol %, and further more preferably 7.0 mol %.

This allows the balance between the hydrophilicity and hydrophobicity of the polyester to be more satisfactory and allows the dispersion stability of the resin particles in the ink-jet ink composition, the storage stability of the ink-jet ink composition, the water resistance and oil resistance of the recorded material manufactured using the ink-jet ink composition, and the like to be more excellent. In addition, the coloring properties of the recorded portion of the recorded material manufactured using the ink-jet ink composition are allowed to be more excellent.

In the present specification, the term “degree of sulfonation of polyester” refers to the proportion of a monomer having a sulfo group in all monomers forming the polyester.

The lower limit of the acid value of the polyester forming the resin particles is preferably 1.0 mg-KOH/g, more preferably 1.5 mg-KOH/g, and further more preferably 2.0 mg-KOH/g. The upper limit of the acid value of the polyester forming the resin particles is preferably 15 mg-KOH/g, more preferably 10 mg-KOH/g, and further more preferably 5.0 mg-KOH/g.

This allows the balance between the hydrophilicity and hydrophobicity of the polyester to be more satisfactory and allows the dispersion stability of the resin particles in the ink-jet ink composition, the storage stability of the ink-jet ink composition, the water resistance and oil resistance of the recorded material manufactured using the ink-jet ink composition, and the like to be more excellent. In addition, the coloring properties of the recorded portion of the recorded material manufactured using the ink-jet ink composition are allowed to be more excellent.

The lower limit of the number-average molecular weight of the polyester forming the resin particles is preferably 3,000, more preferably 6,000, and further more preferably 10,000. The upper limit of the number-average molecular weight of the polyester forming the resin particles is preferably 25,000, more preferably 20,000, and further more preferably 18,000.

This enables both the fixability of the polyester to recording media and the durability the recorded material manufactured using the ink-jet ink composition to be ensured at a higher level. In addition, coloring properties of the colorant in various recording media are allowed to be more excellent.

The lower limit of the glass transition temperature of the polyester forming the resin particles is preferably 0° C., more preferably 25° C., and further more preferably 40° C. The upper limit of the glass transition temperature of the polyester forming the resin particles is preferably 90° C., more preferably 75° C., and further more preferably 70° C.

This enables both the fixability of the polyester to recording media and the durability the recorded material manufactured using the ink-jet ink composition to be ensured at a higher level.

The lower limit of the content of the polyester in the resin particles is preferably 50.0% by mass, more preferably 60.0% by mass, and further more preferably 70.0% by mass. The upper limit of the content of the polyester in the resin particles is preferably 99.5% by mass, more preferably 99.0% by mass, and further more preferably 98.5% by mass.

### 1-3-2. Another Component

The resin particles may contain a component other than the above-mentioned polyester and colorant. In this item, such a component is hereinafter referred to as the “other component”.

Examples of the other component include resin materials other than the polyester; various dispersants; emulsifiers; water; water-soluble organic solvents below; surfactants; penetrants such as triethylene glycol monomethyl ether, triethylene glycol monobutyl ether, diethylene glycol monomethyl ether, 1,2-hexanediol, 1,2-pentanediol, 1,2-butanediol, and 3-methyl-1,5-pentanediol; drying retarders such as triethanolamine; pH adjustors; chelating agents such as ethylenediaminetetraacetic acid; preservatives; fungicides; and rust preventives. For example, a compound having an isothiazoline ring structure in a molecule can be satisfactorily used as a preservative or a fungicide.

The content of the component other than the polyester and the colorant in the resin particles is preferably 6.0% by mass or less and more preferably 5.0% by mass or less.

### 1-4. Water-Soluble Organic Solvent

The ink-jet ink composition may contain a water-soluble organic solvent.

This enables the viscosity of the ink-jet ink composition to be satisfactorily adjusted and enables moisture-retaining properties of the ink-jet ink composition to be increased. As a result, droplets can be stably ejected by the ink jet process.

Examples of the water-soluble organic solvent contained in the ink-jet ink composition include glycerin, propylene glycol, and 2-pyrrolidone.

When these solvents are contained, the rate of evaporation can be moderated by excellent moisture-retaining ability and droplets can be more stably ejected.

The lower limit of the content of the water-soluble organic solvent contained in the ink-jet ink composition is not particularly limited, is preferably 0% by mass, is more preferably 1.0% by mass, and is further more preferably 3.0% by mass. The upper limit of the content of the water-soluble organic solvent contained in the ink-jet ink composition is not particularly limited, is preferably 30.0% by mass, is more preferably 25.0% by mass, and is further more preferably 20.0% by mass.

This clearly exhibits an effect due to the fact that the above-mentioned water-soluble organic solvent is contained.

### 1-5. Another Component

The ink-jet ink composition may contain a component other than the above-mentioned components. In this item, such a component is hereinafter referred to as the “other component”.

Examples of the other component include resin materials other than the polyester; various surfactants; various dispersants; emulsifiers; penetrants such as triethylene glycol monomethyl ether, triethylene glycol monobutyl ether, diethylene glycol monomethyl ether, 1,2-hexanediol, 1,2-pentanediol, 1,2-butanediol, and 3-methyl-1,5-pentanediol; drying retarders such as triethanolamine; pH adjustors; chelating agents such as ethylenediaminetetraacetic acid; preservatives; fungicides; and rust preventives. Resin particles free from those other than the polyester may be contained as the other component. For example, a compound having an isothiazoline ring structure in a molecule can be satisfactorily used as a preservative or a fungicide.

In particular, when the ink-jet ink composition contains a surfactant, the wettability of the ink-jet ink composition to recording media is allowed to be more satisfactory, which is advantageous in obtaining better image quality.

For example, various surfactants such as anionic surfactants, cationic surfactants, and nonionic surfactants can be used as a surfactant contained in the ink-jet ink composition.

More specifically, examples of the surfactant contained in the ink-jet ink composition include acetylenic surfactants, silicone surfactants, and fluorinated surfactants.

The content of the other component in the ink-jet ink composition is preferably 6.0% by mass or less and more preferably 5.0% by mass or less. Incidentally, when a plurality of types of other components are contained, the sum of the contents of these preferably meets the above condition.

### 1-6. Other Conditions

The lower limit of the surface tension of the ink-jet ink composition at 25° C. is not particularly limited, is preferably 20 mN/m, is more preferably 21 mN/m, and is further more preferably 23 mN/m. The upper limit of the surface tension of the ink-jet ink composition at 25° C. is not particularly limited, is preferably 50 mN/m, is more preferably 40 mN/m, and is further more preferably 30 mN/m.

This allows a nozzle of a recording apparatus with an ink jet system to be unlikely to be clogged and further enhances the ejection stability of the ink-jet ink composition. In addition, even when the nozzle is clogged, capping the nozzle, that is, recovery by capping is allowed to be more excellent.

Incidentally, the surface tension used may be a value measured by the Wilhelmy method. For example, a surface tensiometer, CBVP-7, manufactured by Kyowa Interface Science Co., Ltd. or the like can be used to measure the surface tension.

The lower limit of the viscosity of the ink-jet ink composition at 25° C. is not particularly limited, is preferably 2 mPa·s, is more preferably 3 mPa·s, and is further more preferably 4 mPa·s. The upper limit of the viscosity of the ink-jet ink composition at 25° C. is not particularly limited, is preferably 30 mPa·s, is more preferably 20 mPa·s, and is further more preferably 10 mPa·s.

This further enhances the ejection stability of the ink-jet ink composition.

The viscosity can be measured at 25° C. using, for example, a rheometer, MCR-300, manufactured by Physica or the like in such a manner that the shear rate is increased from 10 s⁻¹ to 1,000 s⁻¹ and the viscosity at a shear rate of 200 s⁻¹ is read.

When the ink-jet ink composition according to the present disclosure is ink, the ink is usually used in a recording apparatus by the ink jet process in such a state that the ink is stored in a container such as a cartridge, a bag, or a tank. In other words, a recording apparatus according to the present disclosure includes a container such as a cartridge that stores ink which is the ink-jet ink composition according to the present disclosure.

### 2. Method for Manufacturing Recorded Material

Next, a method for manufacturing a recorded material according to the present disclosure is described.

The method for manufacturing the recorded material according to the present disclosure includes an application step of applying the above-mentioned ink-jet ink composition according to the present disclosure to a recording medium by ejecting the ink-jet ink composition by an ink jet process.

This enables the method for manufacturing the recorded material to be provided such that the recorded material can be satisfactorily manufactured so as to have a recorded portion with excellent texture and excellent durability.

The method for manufacturing the recorded material according to the present disclosure preferably further includes a heating step of heating the recording medium provided with the ink-jet ink composition in addition to the above-mentioned application step. This enables the above-mentioned effects to be more effectively exhibited.

### 2-1. Application Step

In the application step, the ink-jet ink composition is ejected by an ink jet system and is applied to the recording medium. The ink-jet ink composition can be ejected by the ink jet system using a known ink jet recording apparatus. A piezoelectric system, a system in which ink is ejected using bubbles generated by heating the ink, or the like can be used as an ejection method. In particular, the piezoelectric system is preferable from a viewpoint that the ink-jet ink composition is unlikely to alter.

In the application step, a plurality of types of ink-jet ink compositions according to the present disclosure may be used in combination. More specifically, for example, a plurality of types of ink-jet ink compositions different in the composition or content of a colorant may be used in combination.

In the application step, ink other than the ink-jet ink composition according to the present disclosure may be used.

### 2-2. Recording Medium

Examples of a material forming the recording medium include, but are not limited to, resin materials such as polyurethane, polyethylene, polypropylene, polyester, polyamide, and acrylic resins; paper; glass; metal; ceramics; leather; wood; earthenware; concrete; fibers made of at least one of these; various natural fibers such as silk, wool, cotton, hemp, cellulose, and linters; synthetic fibers such as polyester, polyamide (nylon), acrylate, and polyurethane; and semi-synthetic fibers such as rayon, cupra, and acetates. One or more selected from these can be used alone or in combination. The recording medium used may be one having a three-dimensional shape such as a sheet shape, a spherical shape, or a cuboid shape.

When the recording medium is one made of a material containing polyester, particularly one made of a material containing polytrimethylene terephthalate, the adhesion between the recording medium and a recorded portion due to the ink-jet ink composition according to the present disclosure is allowed to be more excellent.

In particular, the recording medium is preferably fabric.

Fabric dyeing has a large demand for printed T-shirts and printing by ironing or the like is in common use. On the other hand, for recorded materials obtained by providing a recorded portion on such fabric, texture, particularly smoothness, flexibility, the durability of the recorded portion, or the like is required. According to the present disclosure, such a requirement can be met. Thus, when the recording medium is fabric, an effect due to the present disclosure is more clearly exhibited.

For example, various textiles such as plain weaves, twill weaves, satin weaves, modified plain weaves, modified twill weaves, modified satin weaves, fancy weaves, figured weaves, single ply weaves, double weaves, multiple weaves, warp pile weaves, weft pile weaves, and leno cloth can be used as fabric.

The thickness of fibers forming the fabric may be, for example, 10 d to 100 d.

Examples of the fibers forming the fabric include polyester fibers, nylon fibers, triacetate fibers, diacetate fibers, polyamide fibers, cellulose fibers, and blends of two or more of these fibers. For example, blends of these fibers and regenerated fibers such as rayon or natural fibers such as cotton, silk, and wool may be used.

The recording medium used may be a film used in a bending or stretching mode. This more clearly exhibits, for example, an effect, such as the fact that a recorded portion which has low tackiness and excellent texture, which is excellent in stretchability, and which is excellent in adhesion with the recording medium can be formed, due to the present disclosure.

### 2-3. Heating Step

After the above-mentioned application step, the recording medium provided with the ink-jet ink composition is heated. This fixes the colorant to the recording medium together with the polyester, whereby the recorded material is obtained.

The lower limit the heating temperature in this step is not particularly limited, is preferably 80° C., is more preferably 85° C., and is further more preferably 90° C. The upper limit the heating temperature in this step is not particularly limited, is preferably 180° C., is more preferably 160° C., and is further more preferably 150° C.

This enables the energy required to manufacture the recorded material to be reduced and enables the production efficiency of the recorded material to be enhanced. In addition, coloring properties of the recorded material that is obtained can be enhanced. Recording media with relatively low heat resistance can be satisfactorily used, which further broadens the range of options for recording media. Unintentional discoloring, the change of optical density, and the like due to heating after the manufacture of the recorded material, for example, heat treatment such as washing/cleansing with hot water, heat drying with a dryer, ironing, or the like can be satisfactorily prevented. When the heating temperature in this step is in the above range, the reduction in texture of the recorded portion can be effectively prevented.

The heating time in this step depends on the heating temperature. The lower limit of the heating time in this step is preferably 0.2 seconds, more preferably one second, and further more preferably five seconds. The upper limit of the heating time in this step is preferably 300 seconds, more preferably 60 seconds, and further more preferably 30 seconds.

This enables the energy required to manufacture the recorded material to be reduced and enables the production efficiency of the recorded material to be enhanced. In addition, coloring properties of the recorded material that is obtained can be enhanced. Recording media with relatively low heat resistance can be satisfactorily used, which further broadens the range of options for recording media. When the heating time in this step is in the above range, the reduction in texture of the recorded portion can be effectively prevented.

This step may be performed in such a manner that a surface of the recording medium provided with the ink-jet ink composition is heated in such a state that the recording medium is apart from a heating member or in such a manner that the recording medium provided with the ink-jet ink composition is heated in such a state that the recording medium is in close contact with the heating member.

The heating step may be performed simultaneously with the application step. More specifically, for example, the recording medium to which the ink-jet ink composition is applied is preheated and may be heated after the ink-jet ink composition comes into contact with the ink-jet ink composition. In this case, for example, heating may be continuously performed before and after the ink-jet ink composition is applied to the recording medium or heating may be restarted after heating the recording medium provided with the ink-jet ink composition is suspended.

### 3. Recording Apparatus

Next, a recording apparatus according to the present disclosure is described.

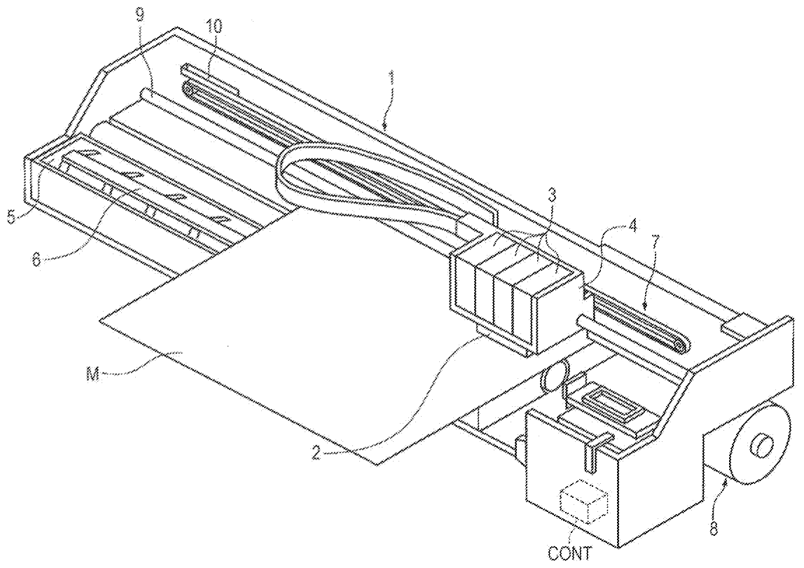

FIG. 1s a schematic perspective view of a recording apparatus according to a preferred embodiment of the present disclosure.

The recording apparatus is described below using an on-carriage type of printer including a carriage and an ink cartridge mounted thereon as an example. In this embodiment, the recording apparatus is not limited to the on-carriage type of printer and may be, for example, an off-carriage type of printer including an ink cartridge fixed to an outer portion.

Incidentally, a printer which is a recording apparatus described below is a serial printer which includes a carriage moving in a predetermined direction and an ink jet head, mounted thereon, for recording and in which droplets are ejected onto a recording medium by the movement of the ink jet head in association with the movement of the carriage. The recording apparatus according to the present disclosure is not limited to such a serial printer and may be a line printer. The line printer is a printer which includes an ink jet head wider than the width of a recording medium and in which the ink jet head does not move and ejects droplets onto a recording medium.

In drawings used for description below, in order to show members in a recognizable size, the scale of each member is appropriately varied.

A recording apparatus 1 according to the present disclosure includes an ink jet head 2 configured to eject the above-mentioned ink-jet ink composition according to the present disclosure toward a recording medium M by an ink jet process and performs the above-mentioned method for manufacturing the recorded material according to the present disclosure.

This enables a recording apparatus capable of satisfactorily manufacturing a recorded material which has a recorded portion with excellent texture and which is excellent in durability to be provided.

In particular, as shown in FIGURE, the recording apparatus 1 includes the ink jet head 2, ink cartridges 3, a carriage 4, a platen 5, a heating mechanism 6, a carriage movement mechanism 7, a medium feed mechanism 8, a guide rod 9, a linear encoder 10, and a control section CONT.

The control section CONT controls the operation of the whole recording apparatus 1.

The carriage 4 carries the ink jet head 2 as described below and is detachably fitted with the ink cartridges 3. The ink cartridges 3 supply the ink-jet ink composition to the ink jet head 2.

The platen 5 is disposed below the ink jet head 2 such that the recording medium M is transported.

The heating mechanism 6 heats the recording medium M. Since the recording apparatus 1 includes the heating mechanism 6, which heats the recording medium M as described above, a recorded portion due to the ink-jet ink composition can be satisfactorily fixed to the recording medium M. In particular, the recorded portion can be satisfactorily fixed without using any apparatus different from the recording apparatus 1.

The carriage movement mechanism 7 moves the carriage 4 in a medium width direction of the recording medium M.

The medium feed mechanism 8 transports the recording medium M in a medium feed direction. Herein, the medium width direction is a main scanning direction that is an operation direction of the ink jet head 2. The medium feed direction is a direction perpendicular to the main scanning direction and is a sub-scanning direction in which the recording medium M moves.

The ink jet head 2 is a unit that applies the ink-jet ink composition to the recording medium M and includes a plurality of nozzles (not shown) on a surface facing the recording medium M to which ink is applied. The nozzles are arranged in a row, whereby a nozzle surface is formed on a surface of a nozzle plate.

A system for ejecting the ink-jet ink composition from the nozzles is, for example, a piezoelectric system in which a pressure and a recording information signal are applied to the ink-jet ink composition together with a piezoelectric element such that droplets of the ink-jet ink composition are ejected and are recorded.

Referring to FIGURE, the ink cartridges 3, which supply the ink-jet ink composition to the ink jet head 2, are independent four cartridges. The four cartridges are filled with, for example, different types of ink-jet ink compositions. The ink cartridges 3 are detachably attached to the ink jet head 2. In an example shown in FIGURE, the number of the cartridges is four. The number of the cartridges is not limited to four. A desired number of cartridges may be mounted.

The carriage 4 is installed in such a state that the carriage 4 is supported with the guide rod 9 which is a support member extending in the main scanning direction. The carriage 4 is moved by the carriage movement mechanism 7 along the guide rod 9 in the main scanning direction. In the example shown in FIGURE, the carriage 4 is moved in the main scanning direction. The carriage 4 is not limited to this and may be moved in the sub-scanning direction in addition to the main scanning direction.

The location of the heating mechanism 6 is not particularly limited and the heating mechanism 6 may be located at a position at which the heating mechanism 6 can heat the recording medium M. In the example shown in FIGURE, the heating mechanism 6 is located at a position which is on the platen 5 and which faces the ink jet head 2. When the heating mechanism 6 is located at the position facing the ink jet head 2, the adhesion position of the ink-jet ink composition on the recording medium M can be reliably heated and the ink-jet ink composition applied to the recording medium M can be effectively dried.

Examples of the heating mechanism 6 include print heater mechanisms which heat the recording medium M by contacting the recording medium M with a heat source, mechanisms which emit infrared rays or microwaves that are electromagnetic waves having a maximum wavelength at about 2,450 MHz, and dryer mechanisms which blow hot air.

Conditions for heating the recording medium M by the heating mechanism 6, for example, the timing of heating, the heating temperature, the heating time, and the like are controlled by the control section CONT.

The recording apparatus 1 may include a second heating mechanism, which is not shown, in addition to the heating mechanism 6. In this case, the second heating mechanism is placed downstream of the heating mechanism 6 in a transport direction of the recording medium M. This enhances drying properties of the ink-jet ink composition applied to the recording medium M. The second heating mechanism used may be any one of the mechanisms described for the heating mechanism 6.

The linear encoder 10 detects the position of the carriage 4 in the main scanning direction in the form of a signal. A signal detected by the linear encoder 10 is transmitted to the control section CONT in the form of positional information. The control section CONT recognizes the scanning position of the ink jet head 2 based on positional information from the linear encoder 10 and controls the recording operation of the ink jet head 2, that is, the ejection operation thereof, or the like.

Incidentally, the control section CONT is configured to be capable of variably controlling the movement speed of the carriage 4.

### 4. Recorded Material

Next, a recorded material according to the present disclosure is described.

The recorded material according to the present disclosure is a recorded material including a recording medium and a recorded portion formed using an ink-jet ink composition. The recorded portion is made of a material containing a colorant and polyester. The polyester has a sulfo group and contains a diol component having a 1,3-propanediol skeleton and a dicarboxylic acid component.

This enables the recorded material to be provided such that the recorded material has a recorded portion with excellent texture and is excellent in durability.

The recording medium used may be one described above.

The recorded material according to the present disclosure can be satisfactorily manufactured using the above-mentioned ink-jet ink composition according to the present disclosure, method for manufacturing a recorded material, and recording apparatus.

Preferred embodiments of the present disclosure have been described above. The present disclosure is not limited to these embodiments.

The ink-jet ink composition according to the present disclosure may be, for example, one used for ejection by an ink jet system and need not be one for use in the above-mentioned method.

More specifically, the ink-jet ink composition may be one for use in a method further including another step in addition to the above-mentioned steps.

In this case, for example, a step of applying a coat layer to a recording medium or the like is cited as a pretreatment step.

In addition, for example, a step of preheating a recording medium or the like is cited as an intermediate treatment step. For example, a step of cleaning a recording medium or the like is cited as a posttreatment step.

### EXAMPLES

Next, specific examples of the present disclosure are described.

### 5. Preparation of Ink-Jet Ink Composition

### Example 1

First, 1,3-propanediol, neopentyl glycol, terephthalic acid, isophthalic acid, and sodium 5-sulfoterephthalate were used at a ratio of 25:25:23:23:4 on a molar basis, followed by a polycondensation reaction, whereby polyester was synthesized.

To the polyester synthesized as described above, C. I. Disperse Red 60 that was a colorant and 80° C. hot water were added, followed by stirring at 80° C. for four hours. This dispersed the polyester, which had both hydrophobic and hydrophilic properties, in water in the form of colored resin particles in such a manner that hydrophilic groups were directed outward, hydrophobic groups were directed inward, and the colorant was incorporated.

Thereafter, an aqueous dispersion of resin particles made of the polyester and the colorant was obtained by cooling.

To the aqueous dispersion of the resin particles, Olfine E1010 (produced by Nissin Chemical Industry Co., Ltd.) as a surfactant, glycerin as a water-soluble organic solvent, triethylene glycol monobutyl ether as a penetrant, ant water were added, followed by stirring and then filtration, whereby an ink-jet ink composition with a composition shown in Table 2 was obtained.

### Examples 2 to 11

Ink-jet ink compositions were prepared in substantially the same manner as that used in Example 1 except that the type of monomers used to synthesize polyester and the ratio of the monomers were adjusted such that the monomer composition of the polyester was as shown in Table 1, a colorant used was as shown in Table 2, and the composition of each ink-jet ink composition was as shown in Table 2.

### Comparative Examples 1 to 4

Ink-jet ink compositions were prepared in substantially the same manner as that used in Example 1 except that the type of monomers used to synthesize polyester and the ratio of the monomers were adjusted such that the monomer composition of the polyester was as shown in Table 1, a colorant used was as shown in Table 2, and the composition of each ink-jet ink composition was as shown in Table 2. Incidentally, in Comparative Example 1, although the preparation of an aqueous dispersion was attempted, no aqueous dispersion could not be prepared because a sulfo group that was a hydrophilic group was absent. In evaluation results in Table 3, “-” was given.

### Comparative Example 5

An ink-jet ink composition was prepared in substantially the same manner as that used in Example 2 except that SUPERFLEX 500M (produced by Dai-ichi Kogyo Seiyaku Co., Ltd.) that was an emulsion of a urethane resin was used instead of an aqueous dispersion of resin particles made of polyester.

The composition of the polyester forming the resin particles contained in the ink-jet ink composition of each of the examples and the comparative examples was summarized in Table 1 and the composition of the ink-jet ink composition of each of the examples and the comparative examples was summarized in Table 2. In the tables, 1,3-propanediol was represented by “1,3-PD”, methylpropanediol was represented by “MPD”, neopentyl glycol was represented by “NPG”, methylethylpropanediol was represented by “MEPD”, diethylpropanediol was represented by “DEPD”, butylethylpropanediol was represented by “BEPD”, ethylene glycol was represented by “EG”, 1,2-propanediol was represented by “1,2-PD”, 1,4-butanediol was represented by “1,4-BD”, 1,6-hexanediol was represented by “1,6-HD”, 2,5-dihydroxybenzenesulfonic acid was represented by “2,5-DHBSA”, terephthalic acid was represented by “TA”, isophthalic acid was represented by “IA”, 4-carboxymethylbenzoic acid was represented by “4-CMBA”, adipic acid was represented by “AA”, sodium 5-sulfoterephthalate was represented by “5-STA”, sodium 5-sulfoisophthalate was represented by “5-SIA”, SUPERFLEX 500M was represented by “SF500M”, C. I. Disperse Red 60 as a disperse dye was represented by “DR60”, C. I. Direct Blue 199 as a direct dye was represented by “DB199”, Pigment Red 122 as a pigment was represented by “PR122”, carbon black was represented by “CB”, C. I. Solvent Blue 5 as an oily dye was represented by “SB5”, C. I. Disperse Red 364 as a fluorescent sublimation dye was represented by “DR364”, glycerin was represented by “Gly”, triethylene glycol monobutyl ether was represented by “TEGBE”, and Olfine E1010 (produced by Nissin Chemical Industry Co., Ltd.) was represented by “E1010”. All the ink-jet ink compositions of the examples had a surface tension in the range of 23 mN/m to 30 mN/m. The surface tension was measured at 25° C. by the Wilhelmy method using a surface tensiometer (CBVP-7, manufactured by Kyowa Interface Science Co., Ltd.). All the ink-jet ink composition of the examples had a viscosity in the range of 4 mPa·s to 10 mPa·s. The viscosity was measured at 25° C. using a rheometer, MCR-300, (manufactured by Physica) in such a manner that the shear rate was increased from 10 s⁻¹ to 1,000 s⁻¹ and the viscosity at a shear rate of 200 s⁻¹ was read. The polyester contained in each of the ink-jet ink compositions was granular and the average particle size of the polyester was in the range of 60 nm to 200 nm. The polyester contained in the ink-jet ink composition of each of the examples had an acid value in the range of 1 mg-KOH/g to 20 mg-KOH/g, a number-average molecular weight in the range of 2,000 to 20,000, and a glass transition temperature in the range of 40° C. to 80° C.

TABLE 1
Table 1

| | Content [mol %] | | | | | | | | | | |
|---|---|---|---|---|---|---|---|---|---|---|---|
| | Polyvalent alcohol component | | | | | | | | | | |
| | 1,3-PD | MPD | NPG | MEPD | DEPD | BEPD | EG | 1,2-PD | 1,4-BD | 1,6-HD | 2,5-DHBSA |
| 1,3-Propanediol | Present | Present | Present | Present | Present | Present | Absent | Absent | Absent | Absent | — |
| skeleton | | | | | | | | | | | |
| Aromatic | — | — | — | — | — | — | — | — | — | — | — |
| polyvalent | | | | | | | | | | | |
| carboxylic acid | | | | | | | | | | | |
| Sulfo group | Absent | Absent | Absent | Absent | Absent | Absent | Absent | Absent | Absent | Absent | Present |
| Example 1 | 25 | — | 25 | — | — | — | — | — | — | — | — |
| Example 2 | 50 | — | — | — | — | — | — | — | — | — | — |
| Example 3 | 23 | 23 | — | — | — | — | — | — | — | — | 4 |
| Example 4 | — | 25 | 25 | — | — | — | — | — | — | — | — |
| Example 5 | | 25 | | 25 | — | — | — | — | — | — | — |
| Example 6 | | | 25 | — | 25 | — | — | — | — | — | — |
| Example 7 | 25 | | | — | — | 25 | — | — | — | — | — |
| Example 8 | 20 | 10 | 10 | — | — | — | — | — | — | — | — |
| Example 9 | 23 | — | 23 | — | — | — | — | — | — | — | 4 |
| Example 10 | 25 | — | — | — | — | — | 25 | — | — | — | — |
| Example 11 | — | — | 25 | — | — | — | — | — | 25 | — | — |
| Comparative | 25 | — | 25 | — | — | — | — | — | — | — | — |
| Example 1 | | | | | | | | | | | |
| Comparative | — | — | — | — | — | — | 25 | — | 25 | — | — |
| Example 2 | | | | | | | | | | | |
| Comparative | — | — | — | — | — | — | 25 | — | — | 25 | — |
| Example 3 | | | | | | | | | | | |
| Comparative | — | — | — | — | — | — | — | — | 23 | 23 | 4 |
| Example 4 | | | | | | | | | | | |
| Comparative | — | — | — | — | — | — | — | — | — | — | — |
| Example 5 | | | | | | | | | | | |

| | Content [mol %] | | | | | | |
|---|---|---|---|---|---|---|---|
| | Polyvalent carboxylic acid component | | | | | | |
| | TA | IA | 4-CMBA | AA | 5-STA | 5-SIA | SF500M |
| 1,3-Propanediol | — | — | — | — | — | — | — |
| skeleton | | | | | | | |
| Aromatic | Present | Present | Present | Absent | Absent | Absent | — |
| polyvalent | | | | | | | |
| carboxylic acid | | | | | | | |
| Sulfo group | Absent | Absent | Absent | Absent | Present | Present | — |
| Example 1 | 23 | 23 | — | — | 4 | — | — |
| Example 2 | 23 | 23 | — | — | — | 4 | — |
| Example 3 | — | 25 | 25 | — | — | — | — |
| Example 4 | 23 | — | 23 | — | 4 | — | — |
| Example 5 | — | 23 | — | 23 | — | 4 | — |
| Example 6 | 23 | | 23 | — | 4 | — | — |
| Example 7 | 23 | 23 | — | — | 4 | — | — |
| Example 8 | 23 | 23 | — | — | — | 4 | — |
| Example 9 | — | — | — | 50 | — | — | — |
| Example 10 | 46 | — | — | — | 4 | — | — |
| Example 11 | — | 46 | — | — | — | 4 | — |
| Comparative | 23 | 23 | — | — | — | — | — |
| Example 1 | | | | | | | |
| Comparative | — | 23 | 23 | — | 4 | — | — |
| Example 2 | | | | | | | |
| Comparative | 23 | — | 23 | — | — | 4 | — |
| Example 3 | | | | | | | |
| Comparative | 25 | — | — | 25 | — | — | — |
| Example 4 | | | | | | | |
| Comparative | — | — | — | — | — | — | 100 |
| Example 5 | | | | | | | |

TABLE 2
Table 2

| | Content [mol %] | | | | | | | | | | | |
|---|---|---|---|---|---|---|---|---|---|---|---|---|
| | | | | | | | | | Water-soluble | | | |
| | Resin material | | Colorant | | | | | | organic solvent | Penetrant | Surfactant | |
| | Polyester | Urethane resin | DR60 | DB199 | PR122 | CB | SB5 | DR364 | Gly | TEGBE | E1010 | Water |
| Example 1 | 20.0 | — | 2.0 | — | — | — | — | — | 5.0 | 2.0 | 1.0 | 70.0 |
| Example 2 | 20.0 | — | — | 2.0 | — | — | — | — | 5.0 | 2.0 | 1.0 | 70.0 |
| Example 3 | 20.0 | — | — | — | 2.0 | — | — | — | 5.0 | 2.0 | 1.0 | 70.0 |
| Example 4 | 20.0 | — | — | — | — | 2.0 | — | — | 5.0 | 2.0 | 1.0 | 70.0 |
| Example 5 | 20.0 | — | — | — | — | — | 2.0 | — | 5.0 | 2.0 | 1.0 | 70.0 |
| Example 6 | 20.0 | — | — | — | — | — | — | 2.0 | 5.0 | 2.0 | 1.0 | 70.0 |
| Example 7 | 20.0 | — | 2.0 | — | — | — | — | — | 5.0 | 2.0 | 1.0 | 70.0 |
| Example 8 | 20.0 | — | — | 2.0 | — | — | — | — | 5.0 | 2.0 | 1.0 | 70.0 |
| Example 9 | 20.0 | — | — | — | 2.0 | — | — | — | 5.0 | 2.0 | 1.0 | 70.0 |
| Example 10 | 20.0 | — | — | — | — | 2.0 | — | — | 5.0 | 2.0 | 1.0 | 70.0 |
| Example 11 | 20.0 | — | — | — | — | — | 2.0 | — | 5.0 | 2.0 | 1.0 | 70.0 |
| Comparative | 20.0 | — | — | — | — | — | — | 2.0 | 5.0 | 2.0 | 1.0 | 70.0 |
| Example 1 | | | | | | | | | | | | |
| Comparative | 20.0 | — | 2.0 | — | — | — | — | — | 5.0 | 2.0 | 1.0 | 70.0 |
| Example 2 | | | | | | | | | | | | |
| Comparative | 20.0 | — | — | 2.0 | — | — | — | — | 5.0 | 2.0 | 1.0 | 70.0 |
| Example 3 | | | | | | | | | | | | |
| Comparative | 20.0 | — | — | — | 2.0 | — | — | — | 5.0 | 2.0 | 1.0 | 70.0 |
| Example 4 | | | | | | | | | | | | |
| Comparative | — | 20.0 | — | — | — | 2.0 | — | — | 5.0 | 2.0 | 1.0 | 70.0 |
| Example 5 | | | | | | | | | | | | |

### 6. Evaluation

### 6-1. Fixability

The ink-jet ink composition of each of the examples and the comparative examples was ejected toward a cotton fabric as a recording medium using such a recording apparatus as shown in FIGURE such that a predetermined pattern was formed.

Thereafter, an iron as a heating member was brought into contact with a surface of the recording medium that was provided with the ink-jet ink composition, followed by heat treatment at 100° C. for 10 seconds, whereby a recorded material was obtained.

Each obtained recorded material was evaluated for fixability. In particular, color fastness to washing was measured in accordance with JIS L 0844 A-2. A sample was put in a 550 ml container, 100 ml of 50° C. water and 0.5 g of soap were put in the container, the sample was washed using a washing tester. After water washing and drying, the fading of a specimen was measured. The OD value was measured using i1 (manufactured by X-Rite Inc.) and was evaluated. A reduction in OD value of less than 0.2 was rated a good level.

A: No change in OD value.

B: A change in OD value of less than 0.1.

C: A change in OD value of less than 0.2.

D: A change in OD value of less than 0.3.

E: A change in OD value of 0.3 or more.

### 6-2. Coloring Properties

The ink-jet ink composition of each of the examples and the comparative examples was ejected toward a cotton fabric as a recording medium using such a recording apparatus as shown in FIGURE such that a predetermined pattern was formed.

Thereafter, an iron as a heating member was brought into contact with a surface of the recording medium that was provided with the ink-jet ink composition, followed by heat treatment at 100° C. for 10 seconds, whereby a recorded material was obtained.

Each obtained recorded material was evaluated for coloring properties. In particular, a portion of the recorded material that was provided with the ink-jet ink composition was measured for chromaticity using i1 (manufactured by X-Rite Inc.), a magenta color and a cyan color were determined for chromaticity (√a*\hat{ }2+b*\hat{ }2) as measured in the L*a*b* color space, a black color was determined for OD value, and evaluation was performed in accordance with criteria below. It can be said that as the chromaticity and the OD value are larger, coloring properties are more excellent. C or higher was rated a good level.

A: The chromaticity of the magenta color is 75 or more, the chromaticity of the cyan color is 50 or more, and the OD value of the black color is 1.2 or more.

B: The chromaticity of the magenta color is 70 to less than 75, the chromaticity of the cyan color is 45 to less than 50, and the OD value of the black color is 1.0 to less than 1.2.

C: The chromaticity of the magenta color is 65 to less than 70, the chromaticity of the cyan color is 40 to less than 45, and the OD value of the black color is 0.7 to less than 1.0.

D: The chromaticity of the magenta color is 60 to less than 65, the chromaticity of the cyan color is 35 to less than 40, and the OD value of the black color is 0.5 to less than 0.7.

E: The chromaticity of the magenta color is less than 60, the chromaticity of the cyan color is less than 35, and the OD value of the black color is less than 0.5.

### 6-3. Texture of Recorded Material

For the recorded materials, manufactured in above “6-1”, according to the examples and the comparative examples, recorded portions were touched and were evaluated for tackiness in accordance with criteria below. It can be said that as the tackiness is lower and the slipperiness is higher, the texture is more excellent. B or higher was rated a good level.

A: No tackiness and very excellent slipperiness.

B: Low tackiness and sufficient slipperiness.

C: High tackiness and poor slipperiness.

D: Very high tackiness and very poor slipperiness.

### 6-4. Hardness of Recorded Material

The recorded materials, manufactured in above “6-1”, according to the examples and the comparative examples were evaluated for hardness. A measurement method used was a 45° cantilever method of JIS L 1079. Specifically, cloth was horizontally protruded from a desk and the length of a portion in contact with a 45° slope was measured. As the length is smaller, a softer measure is given and as the length is larger, a harder measure is given. Evaluation was performed in accordance with evaluation criteria below. B or higher was rated a good level.

A: Less than 1 cm.

B: Less than 2 cm.

C: Less than 3 cm.

D: Less than 4 cm.

These results are summarized in Table 3.

TABLE 3
Table 3

| | | | Texture of | Hardness of |
|---|---|---|---|---|
| | Fixabil- | Coloring | recorded | recorded |
| | ity | properties | material | material |
| Example 1 | A | A | A | A |
| Example 2 | B | A | A | A |
| Example 3 | A | B | A | A |
| Example 4 | B | A | A | B |
| Example 5 | B | B | A | A |
| Example 6 | B | A | A | B |
| Example 7 | A | A | A | A |
| Example 8 | B | A | A | B |
| Example 9 | A | C | A | B |
| Example 10 | B | B | A | B |
| Example 11 | B | B | A | B |
| Comparative Example 1 | — | — | — | — |
| Comparative Example 2 | D | B | A | D |
| Comparative Example 3 | E | B | A | D |
| Comparative Example 4 | D | D | A | D |
| Comparative Example 5 | E | E | D | A |

As is clear from Table 3, excellent results were obtained in the present disclosure. However, no satisfactory results were obtained in the comparative examples.

Recorded materials were manufactured in substantially the same manner as the above except that a blend fabric of polyester fibers and cotton fibers, a silk fabric, a fabric of polyurethane fibers, a fabric of acrylic fibers, a fabric of polyamide fibers, and paper composed of cellulose fibers were used as recording media. The recorded materials were evaluated in substantially the same manner as the above, whereby substantially the same results as the above were obtained.

What is claimed is:

1. An ink-jet ink composition comprising:
water;
a colorant; and
resin particles made of a material containing polyester, wherein
the polyester has a sulfo group and contains a diol component and a dicarboxylic acid component, and
the diol component contains a diol component having a 1,3-propanediol skeleton.

2. The ink-jet ink composition according to claim 1, comprising a plurality of types of components as the diol component having a 1,3-propanediol skeleton.

3. The ink-jet ink composition according to claim 1, comprising at least one selected from the group consisting of 1,3-propanediol, methylpropanediol, neopentyl glycol, methylethylpropanediol, diethylpropanediol, and butylethylpropanediol as the diol component having a 1,3-propanediol skeleton.

4. The ink-jet ink composition according to claim 1, wherein the polyester further contains at least one of ethylene glycol and 1,2-propanediol as the diol component in addition to the diol component having a 1,3-propanediol skeleton.

5. The ink-jet ink composition according to claim 1, comprising a plurality of types of components as the dicarboxylic acid component.

6. The ink-jet ink composition according to claim 1, wherein the polyester contains a dicarboxylic acid component with a sulfonated chemical structure as the dicarboxylic acid component.

7. The ink-jet ink composition according to claim 1, comprising an aromatic dicarboxylic acid as the dicarboxylic acid component.

8. The ink-jet ink composition according to claim 1, wherein the colorant is at least one selected from the group consisting of a dye, an organic pigment, and an inorganic pigment.

9. The ink-jet ink composition according to claim 1, wherein the colorant is contained in the resin particles.

10. The ink-jet ink composition according to claim 9, wherein the colorant is at least one selected from the group consisting of an oily dye, a disperse dye, a sublimation dye, a fluorescent dye, a direct dye, a pigment, and carbon black.

11. A method for manufacturing a recorded material, comprising an application step of applying the ink-jet ink composition according to claim 1 to a recording medium by ejecting the ink-jet ink composition by an ink jet process.

12. The method for manufacturing a recorded material according to claim 11, further comprising a heating step of heating the recording medium provided with the ink-jet ink composition.

13. The method for manufacturing a recorded material according to claim 11, wherein the recording medium is fabric.

14. The method for manufacturing a recorded material according to claim 12, wherein a heating temperature of the recording medium in the heating step is 80° C. to 180° C.

15. A recorded material comprising:
a recording medium; and
a recorded portion formed using an ink-jet ink composition, wherein
the recorded portion is made of a colorant and a material containing polyester, and
the polyester has a sulfo group and contains a diol component having a 1,3-propanediol skeleton and a dicarboxylic acid component.

16. A recording apparatus comprising an ink jet head configured to eject the ink-jet ink composition according to claim 1 toward a recording medium by an ink jet process.

17. The recording apparatus according to claim 16, further comprising a heating mechanism configured to heat the recording medium.
